(19) United States
(12) Patent Application Publication
(10) Pub. No.: US 2022/0374729 A1
(43) Pub. Date: Nov. 24, 2022

(54) ASSESSING ENTITY PERFORMANCE USING MACHINE LEARNING

(71) Applicant: Vérité Systems, LLC, Atlanta, GA (US)

(72) Inventors: Sean E. Rowe, Atlanta, GA (US); John O. Calhoun, Smyrna, GA (US); Miles Booth McDonald, Tifton, GA (US)

(21) Appl. No.: 17/751,329

(22) Filed: May 23, 2022

Related U.S. Application Data
(60) Provisional application No. 63/191,526, filed on May 21, 2021.

(51) Int. Cl. G06N 5/02; G06Q 10/06

(52) U.S. Cl. CPC G06N 5/022; G06Q 10/06398

(57) ABSTRACT

The present disclosure relates to assessing entity performance through machine learning. Entity data associated with an entity can be collected, where the data corresponds to a plurality of factors. At least one classification can be generated based at least in part on the entity data. A performance score can be generated for the entity based at least in part on the at least one classification and the performance data, wherein the performance score comprises at least one sub-score corresponding to at least one component of the performance score

### CROSS-REFERENCE TO RELATED APPLICATIONS

This application claims the benefit of and priority to co-pending U.S. Provisional Application No. 63/191,526, entitled “ASSESSING ENTITY PERFORMANCE USING MACHINE LEARNING,” and filed on May 21, 2021, which is incorporated by reference herein as if set forth in its entirety.

### BACKGROUND

When exploring employment options, a potential employee may desire evaluate potential employers using objective factors. Likewise, employers may be desire to determine whether a potential employee is desirable for a position based on such factors.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows an example of a networked environment, according to various embodiments of the present disclosure.

FIG. 2 shows a sequence diagram that provides one example of functionality implemented by components of the networked environment, according to various embodiments of the present disclosure.

FIG. 3 shows a sequence diagram that provides one example of functionality implemented by components of the networked environment, according to various embodiments of the present disclosure.

### DETAILED DESCRIPTION

The present disclosure relates to assessing entity performance through machine learning. Various embodiments introduce the performance score, an algorithmic approach to provide a quantifiable metric for employees, employers, and other entities. The performance score can be a representative snapshot of an individual's career and can be shared with employers, and potentially other entities such as rental agencies and landlords, to provide an additional layer of certainty. The performance score can provide an unbiased and metric-driven snapshot of an employee's performance, experience, and consistency. Using these factors, as well as an extensive set of sub-factors, the performance score algorithm can be used to calculate an accurate score for a user.

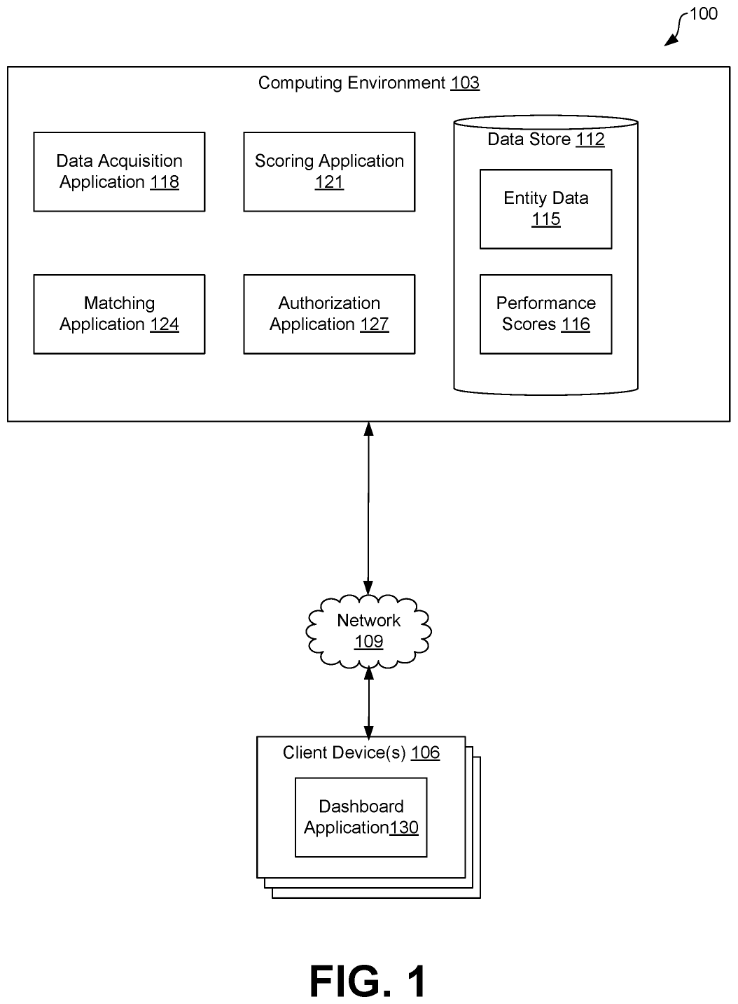

FIG. 1 shows an example of a networked environment 100. The networked environment 100 can include a computing environment 103 and client device(s) 106 in communication through a network 109.

The network 109 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks. The network 109 can include wide area networks (WANs) and local area networks (LANs). These networks can include wired or wireless components or a combination thereof. Wired networks can include Ethernet networks, cable networks, fiber optic networks, and telephone networks, such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can be embodied as one or more computers, computing devices, or computing systems. In certain embodiments, the computing environment 103 can include one or more computing devices arranged, for example, in one or more servers or computer banks. The computing device or devices can be located at a single installation site or distributed among different geographical locations. The computing environment 103 can include a plurality of computing devices that together embody a hosted computing resource, a grid computing resource, or other distributed computing arrangement. In some cases, the computing environment 103 can be embodied as an elastic computing resource where an allotted capacity of processing, network, storage, or other computing-related resources vary over time. As further described below, the computing environment 103 can also be embodied, in part, as certain functional or logical (e.g., computer-readable instruction) elements or modules as described herein.

The computing environment 103 can include a data store 112. The data store 112 can include memory of the computing environment 103, mass storage resources of the computing environment 103, or any other storage resources on which data can be stored by the computing environment 103. The data store 112 can include one or more databases, such as a structured query language (SQL) database, a non-SQL database, or other appropriate database. The data stored in the data store 112, for example, can be associated with the operation of the various applications or functional entities described below. The data stored in the data store 112, for example, can be associated with the operation of the various applications or functional entities described below. The data stored in the data store 112 can include entity data 115, performance scores 116, and potentially other data.

The components executed in the computing environment 103 can include, for example, a data acquisition application 118, a scoring application 121, a matching application 124, an authorization application 127, and potentially other applications, services, processes, systems, engines, or functionality not discussed in detail herein.

The data acquisition application 118 can collect data associated with entities for storage in the data store 112 as entity data 115. In some examples, the data acquisition application 118 can collect data associated with employee entities for the entity data 115. For example, the data acquisition application 118 can collect data regarding an employee's employment history, biographical data, attendance, reliability, employment performance, or other data.

The data acquisition application 118 can collect data associated with employer entities for the entity data 115. The data collected by the data acquisition application 118 for employer entities can be different from data collected for employer entities. For example, factors such as employee turnover, earnings per share (EPS), verified employee reviews, and adherence to predetermined guidelines can be collected by the data acquisition application 118 and stored in the entity data 115.

The data acquisition application 118 can automatically collect and consolidate data from multiple sources over time to generate entity data 115 associated with a particular entity. The data acquisition application 118 can collect data from various sources such as public records, data from past and current employees and employers, financial institutions, and other sources. The data acquisition application 118 can acquire this data automatically and without input from an entity once that an account for an entity has been enrolled with the data acquisition application 118.

In some implementations, the data acquisition application 118 can re-identify an entity if entity data 115 associated with that entity becomes associated with a different account. For example, if an employee entity becomes unaffiliated from an employer entity, data associated with that employee entity may not be removed from the entity data 115. That way, if this employee entity later becomes associated with a different employer entity, the employee entity cannot sanitize their entity data 115 or otherwise prevent relevant entity data 115 from being accessible to the new employee entity. In some implementations, the data acquisition application 118 can preserve unique identifiers associated with an employee entity to prevent the creation of multiple entity accounts by the same individual. Instead, the data acquisition application 118 can implement an anonymization process wherein data can still be linked to an internally created unique identifier but may not linked to an individual's identity.

The scoring application 121 can determine a performance score 116 for an entity based on one or more factors based on the entity data 115. For example, the scoring application 121 can determine a performance score 116 for an employee entity based on factors such as tenure, job history, employer reviews, or other factors derived from entity data 115 associated with the employee entity. As another example, the scoring application 121 can determine a performance score 116 for an employer entity based on factors such as employee turnover, earnings per share (EPS), verified employee reviews, adherence to predetermined guidelines, and other factors derived from.

Using these factors, the scoring application 121 can provide a singular, consistent metric that can convey reliability and insight into the entity's expected performance. Given the potential for industry-specific influences, scoring application 121 can use unique factors for each industry, so performance scores 116 can be industry-specific. In some implementations, a performance score 116 can comprise at least one sub-score, where a sub-score can comprise a score corresponding to one of the factors based on the entity data 115.

In some implementations, the scoring application 121 can determine a performance score 116 for an entity using machine learning, together with that entity's associated entity data 115. For example, the scoring application 121 can employ one or more machine learning classification approaches. The scoring application 121 can use a machine learning classifier to generate a classification model, which can be used to produce a performance score 116 for an entity. Based on the one or more machine learning classification approaches and the resulting classification model, the scoring application 121 can generate a plurality of classes that can correspond to individual score values.

To generate a performance score 116, the scoring application 121 can, based on associated entity data 115, classify an entity into one of a plurality of classes, where each class represents a possible value for the entity's performance score 116. In other words, the scoring application 121 can classify a particular entity into one of the plurality of classes based on the entity's entity data 115, and that entities class can comprise a value for the entity's performance score 116.

In some implementations, the scoring application 121 can employ the one or more machine learning approaches to classify entity data 115 based on what impact that that the entity data 115 may have on the employee entity's performance score 116. The scoring application 121 can learn how a particular factor from entity data 115 should impact an entity's performance score 116 based on information regarding entities whose entity data 115 includes a same or similar factor. For example, suppose a factor is correlated with an employee entity's loss of position. Then, that factor may be more likely to negatively impact the performance scores 116 of other employee entities. As another example, if a factor is correlated with an entity receiving a promotion, that factor may then be more likely to positively impact the performance scores 116 of other employee entities. The degree to which a factor can affect a performance score 116 can likewise vary.

The matching application 124 can implement a search functionality that can connect employer entities and potential employee entities. The matching application 124 can allow potential employee entities to leverage search functions and find employer entities. Likewise, the matching application 124 can allow employer entities to find potential employee entities. The matching application 124 can thereby allow employer entities and potential employee entities to arrange interviews, for example.

When an entity initiates a search, a client device 106 associated with the search entity can provide the matching application 124 with a search request specifying one or more search criteria. The matching application 124 can identify any entities associated with entity data 115 that satisfies the one or more search criteria. The matching application 124 can provide a notification to each entity that satisfies the one or more search criteria. The notification can comprise the one or more search criteria that the notified entity satisfies, as well as an indication that the notified entity has satisfied the one or more search criteria. The searching entity can subsequently terminate a search by notifying the matching application 124, and the matching application 124 can no longer provide notifications to entities that satisfy the one or more search.

In addition, an entity can provide the matching application 124 with one or more notification criteria. The one or more notification criteria can comprise one or more characteristics that should be present within entity data 115 associated with a searching entity before a notification regarding that searching entity is presented to the specifying entity. The matching application 124 can then provide a notification to that entity only if the searching entity satisfies the one or more notification criteria. The matching application 124 can determine whether a searching entity satisfied one or more notification criteria by comparing the one or more notification criteria with entity data 115 associated with the searching entity.

An entity can indicate to the matching application 124 that the entity would like to disable receiving notifications. In that case, the matching application 124 can refrain from providing any notifications to that entity and instead store any notifications in the entity data 115 in association with that entity. If the matching application 124 subsequently receives an indication that the entity would like to enable receiving notifications, the matching application 124 can provide any notifications stored in the entity data 115 in association with that entity to a client device 106 associated with that entity. In some implementations, however, the matching application 124 may provide only notifications that were generated within a predetermined time period.

In some implementations, the matching application 124 can notify an employer entity when an associated employee entity has applied to another position or has reciprocated interest in an employer that satisfied the employee entity's one or more search criteria. The matching application 124 can thereby mitigate employee entities ending their affiliation with an employer entity with insufficient notice. In some implementations, an employee entity may or must agree that the matching application 124 may provide such notifications to the corresponding employer entity as a condition of enrollment.

In some implementations, the matching application 124 can receive from an employee entity an indication that the employee entity does not wish to receive notifications from employer entities with which the employee entity is not affiliated. In some implementations, the matching application 124 can refrain from providing any notifications from prospective employer entities. In other implementations, the matching application 124 can provide such notifications to the employee entity, but those notifications can be withheld based at least in part on one or more settings of the employee entity's dashboard application 130.

The authorization application 127 can manage access to an entity's entity data 115 by other entities. When an employer entity and a potential employee entity, for example, initiate a hiring process, the authorization application 127 can provide a client device 106 associated with the employer entity with an authorization key. The authorization key can be a token that facilitates an information transaction between an employee entity and an employer entity. For example, an authorization key can allow an employer entity to access data associated with potential employee entity that may not otherwise be public.

The authorization application 127 can restrict an employer entity's access to at least a portion of entity data 115 associated with the potential employee entity, and vice-versa. For example, without an authorization key associated with a particular entity, other entities may only be able to access less sensitive information associated with the potential employee user like, for example, the employee user's name. In some implementations, entity data 115 can be encrypted. The authorization key can then be used to decrypt at least a portion of the entity data 115.

In some implementations, the authorization application 127 can set time-to-live for the authorization key after which the authorization key expires. That way, an employer entity (or employee entity) may only access entity data 115, performance scores 116, or other data associated with a potential employee entity (or employer entity) during a predefined time period like, for example, during the hiring process. Thus, in these implementations the authorization key can permit selective and time-limited access to encrypted database entries for a potential employee.

The authorization application 127 can generate an entity's authorization key based on one or more access permissions provided the entity. The one or more access permissions can enable the authorization application 127 to generate the authorization key to specify what portions of the entity's entity data 115 one or more other entities can access. For example, the authorization application 127 can specify that an employer entity can only use an authorization key to access portions of the entity data 115 associated with the corresponding employee entity that are relevant to that employer entity. As another example, the authorization application 127 can generate the authorization key that specifies that an employer entity cannot access sensitive personal information that is not relevant during a hiring process.

In some instances, however, a potential employee may not restrict the data accessible using the potential employee's authorization key. This can allow any employer entity with that authorization key to access information like, for example, historical employment data associated with the potential employee entity, along with any other information from the entity data 115 associated with the potential employee entity.

The entity data 115 can represent data regarding one or more entities. This entity data 115 can be collected by the data acquisition application 118 and used to generate performance scores 116 by the scoring application 121. For example, entity data 115 associated with an employee entity can include, for example, information regarding an historical employment data, biographical data, attendance data, reliability data, performance data, or other data. As another example, entity data 115 associated with factors such as employee turnover, earnings per share (EPS), verified employee reviews, and adherence to predetermined guidelines can be collected by the data acquisition application 118 and stored in the entity data 115.

In some implementations, a unique identifier can be stored in association with data associated with an entity within the entity data 115. This unique identifier can be, for example, an identifier generated by the data acquisition application 118. As another example, the unique identifier can be an identifier assigned to the entity by an administrative entity. In the latter example, this unique identifier can be preserved following an entity's unenrollment to prevent the entity from later attempting to re-enroll using a different account. In some implementations, unique identifiers, such as social security numbers, can be preserved to prevent the creation of multiple accounts by the same entity.

A performance score 116 can represent a quantification of an employee entity's performance, experience, consistency, and/or other factors. The performance score 116 itself can be on a spectrum, much like a credit score. As one example, the performance score can range from 200 to 1000 with a starting point of 400. Any suitable scale can be used, however. In some implementations, the performance score can also include sub-scores, which can represent scores for individual components of a performance score.

The client device(s) 106 can represent one or more client devices 106. Each client device 106 can be embodied as any computing device, processing circuit, or processor based device or system, including those in the form of a desktop computer, a laptop computer, a tablet computer, a personal digital assistant, a cellular telephone, a wearable computing device, or a set-top box, among other example computing devices and systems. Depending on its primary purpose or function, for example, the client devices 106 can include various peripheral devices or components. The peripheral devices can include input or communications devices or modules, such as keyboards, keypads, touch pads, touch screens, microphones, cameras, wireless communications modules (e.g., infra-red, WI-FI, or BLUETOOTH®), buttons, switches, or sensors. The peripheral devices can also include displays, indicator lights, speakers, global positioning system (GPS) circuitry, accelerometers, gyroscopes, or other peripheral devices depending upon the primary purpose or function of the client devices 106.

The dashboard application 130 can allow an entity to interface with various applications executing in the computing environment 103. For example, the client dashboard application 124 could be a web browser, a productivity application, a messaging application, or other application. The dashboard application 130 can include a mobile application, a web application, or other interface.

The dashboard application 130 can allow an entity to initiate a search for any other entities that meet one or more specified search criteria. The dashboard application 130 can thereby enable communication between an employer client device 106 and an employee client device 106 to, for example, initiate a hiring process or arrange an interview. To initiate a search, a searching entity can provide the dashboard application 130 with input specifying one or more search criteria. The one or more search criteria can comprise one or more characteristics that the searching entity would find desirable in an employee entity or an employer entity. In response receiving to input specifying one or more search criteria, the dashboard application 130 can generate a search request comprising the one or more specified criteria and provide that search request to the matching application 124.

If an entity satisfies the one or more search criteria, the dashboard application 130 associated with that entity can receive a notification from the matching application 124. That notification can comprise the one or more search criteria specified by the searching entity, as well an indication that the notified entity satisfies those criteria. The searching entity can subsequently terminate a search by notifying the matching application 124, and entities that satisfy the one or more specified criteria can no longer receive notifications associated with the searching entity.

The dashboard application 130 can also allow an entity to specify one or more notification criteria. The one or more notification criteria can comprise one or more characteristics that should be present within entity data 115 associated with a searching entity before a notification regarding that searching entity is presented to the specifying entity.

Thus, an entity may only be presented with notifications associated with searching entities that satisfy the one or more notification criteria. In some implementations, the dashboard application 130 can provide the one or more notification criteria to the matching application 124, and the dashboard application 130 can no longer receive notifications from searching entities that do not meet the one or more notification criteria. In other implementations, the dashboard application 130 can refrain from presenting notifications associated with entities that do not meet the one or more notification criteria.

In some implementations, though, the dashboard application 130 can provide an option to disable (or enable) any such notifications. For example, an employee entity who is not seeking employment can select an option to disable an “availability” setting to prevent the dashboard application 130 from presenting notifications from the matching application 124. As another example, an employer entity that is not seeking to employ an additional employee entity can select an option to disable a “hiring” setting to prevent the dashboard application 130 from presenting notifications from the matching application 124. When an option to disable notifications is selected, the dashboard application 130 can provide to the matching application 124 a request to stop receiving notifications, or the dashboard application 130 can continue to receive notifications but restrict the entity's access to those notifications. However, any notifications that an entity would have received can be stored, by the matching application 124 in the former case or by the dashboard application 130 itself in the latter case. The dashboard application 130 can then present those notifications to the notified entity if that entity selects the option to enable notifications. If a stored notification is associated with an entity that has terminated a search corresponding to the notification, that notification can be removed and not presented to the notified entity.

The dashboard application 130 can provide one or more access permissions to the authorization application 127 for an entity associated with the dashboard application 130. The one or more access permissions can specify what portions of the entity data 115 associated with the entity that should and/or should not be accessible to other entities. The one or more access permissions can be used to generate an authorization key for the entity.

The dashboard application 130 can receive an authorization key for another entity from the authorization application 127. The dashboard application 130 can use the authorization key to decrypt at least a portion of entity data 115 associated with the second entity that is requested and received from the authorization application 127. The portion of the entity data 115 accessible by the dashboard application 130 can depend on one or more access permissions generated by the other entity.

In some implementations, the dashboard application 130 can perform other functionality. For example, the dashboard application 130 can enable an entity to examine the entity's performance score 116, both current and historical, as well as entity data 115 associated with that entity. In some implementations, the dashboard application 130 can enable an entity to track the entity's performance score 116 over a period of time and identify any factors that may have influenced the performance score 116 to change. As another example, the dashboard application 130 can perform simulations that enable an entity to example how a factor may influence the entity's performance score 116. As an additional example, the dashboard application 130 can enable an entity to access data regarding an average performance scores 116 for entities associated with a specified role, area, industry, and/or other criteria.

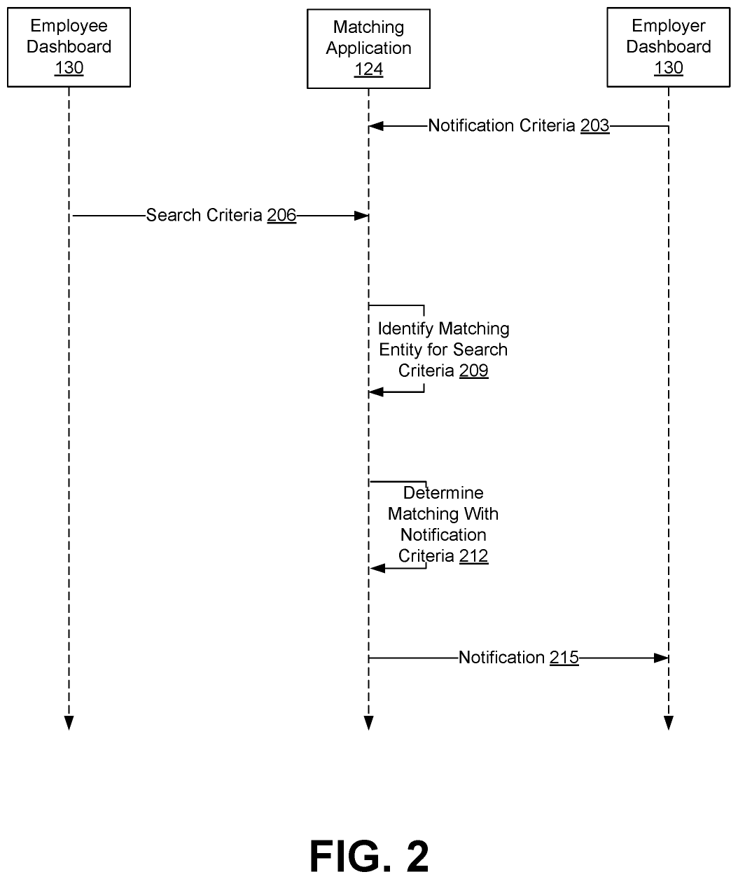

FIG. 2 shows a sequence diagram that provides one example of functionality implemented by components of the networked environment 100. It is understood that the sequence diagram of FIG. 2 provides merely an example of the many different types of functional arrangements that can be employed to implement the portions of the networked environment 100 as described herein. As an alternative, the sequence diagram of FIG. 2 can be viewed as depicting an example of elements of a method implemented within the networked environment 100.

At step 203, a dashboard application 130 executing on a client device 106 associated with a first entity can provide one or more notification criteria to the matching application 124. The first entity dashboard application 130 can receive input specifying one or more notification criteria from the first entity. The one or more notification criteria can comprise one or more characteristics that should be present within entity data 115 associated with the second entity before a notification regarding the second entity is presented to the first entity.

At step 206, a dashboard application 130 executing on a client device 106 associated with a second entity can provide one or more search criteria to the matching application 124. The second entity dashboard application 130 can receive input specifying one or more search criteria from the second entity. The one or more search criteria can comprise one or more characteristics that the second entity would find desirable in an employee entity or an employer entity. In response receiving to input specifying one or more search criteria, the second entity dashboard application 130 can generate a search request comprising the one or more specified criteria and provide that search request to the matching application 124.

At step 209, the matching application 124 can identify any entities that may satisfy the one or more search criteria. To do so, the matching application 124 can compare the one or more search criteria with entity data 115 associated with various entities. In this example, the matching application 124 can identify the first entity as one that satisfies the one or more search criteria.

At step 212, the matching application 124 can determine whether the second entity satisfies the one or more notification criteria. To do so, the matching application 124 can compare the one or more notification criteria with entity data 115 associated with the second entity. In this example, the matching application 124 can determine that the second entity does satisfy the one or more notification criteria.

At step 215, the matching application 124 can provide a notification to the first entity dashboard application 130. The notification can comprise the one or more search criteria that the notified entity satisfies, as well as an indication that the notified entity has satisfied the one or more search criteria.

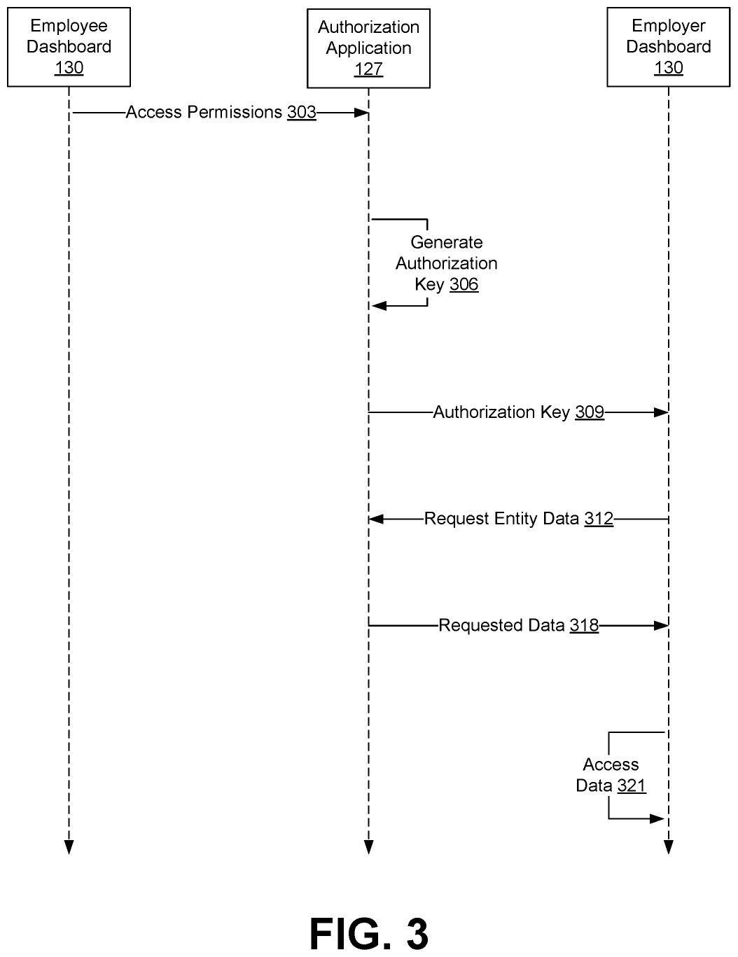

FIG. 3 shows a sequence diagram that provides one example of functionality implemented by components of the networked environment 100. It is understood that the sequence diagram of FIG. 3 provides merely an example of the many different types of functional arrangements that can be employed to implement the portions of the networked environment 100 as described herein. As an alternative, the sequence diagram of FIG. 3 can be viewed as depicting an example of elements of a method implemented within the networked environment 100.

At step 303, the second entity dashboard application 130 can provide one or more access permissions to the authorization application 127. The one or more access permissions can specify what portions of the entity data 115 associated with the second entity that should and/or should not be accessible to the first entity.

At step 306, the authorization application 127 can generate an authorization key. The authorization key can be a token that facilitates an information transaction between the first entity dashboard application 130 and the second entity dashboard application 130. The authorization application 127 can generate the authorization key based on the one or more access permission to specify what portions of the second entity's entity data 115 that the first entity dashboard application 130 can access. In some implementations, the authorization application 127 can set time-to-live for the authorization key after which the authorization key expires. That way, the first entity may only access entity data 115, performance scores 116, or other data associated with a potential employee entity during a predefined time period like, for example, during the hiring process. Thus, in these implementations the authorization key can permit selective and time-limited access to encrypted database entries for a potential employee.

At step 309, the authorization application 127 can provide the authorization key to the first entity dashboard application 130.

At step 312, the first entity dashboard application 130 can request entity data 115 associated with the second entity from the authorization application 127. In some implementations, the first entity dashboard application 130 can request all entity data 115 regarding the second entity that is accessible to the matching application 124. In other implementations, the first entity dashboard application 130 can request only a portion of the entity data 115 regarding the second entity that is accessible to the matching application 124.

At step 315, the authorization application 127 can provide the requested entity data 115 associated with the second entity to the first entity dashboard application 130.

At step 318, the first entity dashboard application 130 can access the requested entity data 115 associated with the second entity. The authorization key can then be used to decrypt at least a portion of the requested entity data 115 associated with the second entity.

The client devices 106 or devices comprising the computing environment 103 can include at least one processor circuit, for example, having a processor and at least one memory device, both of which are coupled to a local interface, respectively. The device can include, for example, at least one computer, a mobile device, smartphone, computing device, or like device. The local interface can include, for example, a data bus with an accompanying address/control bus or other bus structure.

The flowchart(s) and sequence diagram(s) show examples of the functions and operation of the components described herein. The components described herein can be embodied in hardware, software, or a combination of hardware and software. If embodied in software, each element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or several interconnected circuits that implement the specified logical function(s).

The computing environment 103 can include at least one processing circuit. Such a processing circuit can include, for example, one or more processors and one or more storage or memory devices that are coupled to a local interface. The local interface can include, for example, a data bus with an accompanying address/control bus or any other suitable bus structure. Similarly, the client devices 106 can each include at least one processing circuit. Such a processing circuit can include, for example, one or more processors and one or more storage or memory devices that are coupled to a local interface.

The storage or memory devices can store data or components that are executable by the processors of the processing circuit. For example, the data acquisition application 118, scoring application 121, matching application 124, authorization application 127, and/or other components can be stored in one or more storage devices and be executable by one or more processors in the networked environment 100. Similarly, the dashboard application 130, agents, services, applications and/or other components described herein can be stored in one or more storage devices and be executable by one or more processors in the client device 106.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

The client devices 106 can include a display upon which a user interface generated by the dashboard application 130 or another application can be rendered. In some examples, the user interface can be generated using user interface data provided by the computing environment 103. The client device 106 can also include one or more input/output devices that can include, for example, a capacitive touchscreen or other type of touch input device, fingerprint reader, or keyboard.

Although the data acquisition application 118, scoring application 121, matching application 124, authorization application 127, dashboard application 130, and other various systems described herein can be embodied in software or code executed by general-purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagrams of FIGS. 2 and 3 show examples of the functions and operation of the components described herein. The components described herein can be embodied in hardware, software, or a combination of hardware and software. If embodied in software, each element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or several interconnected circuits that implement the specified logical function(s).

Although the sequence diagrams of FIGS. 2 and 3 show a specific order of execution, it is understood that the order of execution can differ from that which is depicted. For example, the order of execution of two or more items can be scrambled relative to the order shown. Also, two or more items shown in succession can be executed concurrently or with partial concurrence. Further, in some examples, one or more of the items shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure.

Therefore, at least the following is claimed:

1. A system, comprising:
at least one computing device comprising a processor and a memory; and
machine-readable instructions stored in the memory that, when executed by the processor, cause the at least one computing device to at least:
collect entity data associated with an entity, the data corresponding to a plurality of factors;
generate at least one classification based at least in part on the entity data; and
generate a performance score for the entity based at least in part on the at least one classification and the performance data, wherein the performance score comprises at least one sub-score corresponding to at least one component of the performance score.
